(19) United States
(12) Patent Application Publication
(10) Pub. No.: US 2007/0248796 A1
(43) Pub. Date: Oct. 25, 2007

(54) Vehicle window glass

(75) Inventors: Toyoyuki Teranishi, Tokyo (JP); Yasukazu Kanatani, Tokyo (JP); Yoshimitsu Matsushita, Tokyo (JP); Toru Maruyama, Tokyo (JP)

Correspondence Address: COHEN PONTANI LIEBERMAN & PAVANE LLP;Thomas Langer, Suite 1210, 551 Fifth Avenue, New York, NY, 10176, US

(73) Assignee: Nippon Sheet Glass Company, Limited, Tokyo (JP)

(21) Appl. No.: 11/784,386

(22) Filed: Apr. 6, 2007

(30) Foreign Application Priority Data
Apr. 7, 2006 (JP) 2006-106217 (PAT.

(51) Int. Cl. B32B 23/02; B32B 17/06

(52) U.S. Cl. 428/192; 428/426

(57) ABSTRACT

A vehicle window glass that can reduce the load on the opening and closing mechanism when the window glass to which frozen water or snow is adhering is changed from a closed state to an open state. The vehicle window glass openably and closably is sandwiched between weather strips comprising lip portions installed in a window portion of the vehicle and has a water-repellent coating formed on at least on one principal surface of the window glass. The water-repellent coating is formed at least in a first contact portion at which an outer principal surface of the window glass and the lip portion placed outside the vehicle contact each other while the window glass is closed.

### BACKGROUND OF THE INVENTION

1. Field of the Invention

The present invention relates to a vehicle window glass, and in particular, to a vehicle window glass such as a door glass or a roof glass which is openably and closably installed in a vehicle window.

2. Description of the Related Art

A window glass such as a door glass or a roof glass has been known which is openably and closably installed in a vehicle window and which has a water-repellent coating formed on an outer principal surface of the glass window (hereinafter referred to as “the exterior surface”) in order to improve the visibility. The water-repellent coating formed on the glass surface is known to facilitate the peeling-off of an ice layer adhering to the glass surface on which the water-repellent coating is formed (see, for example, Japanese Laid-Open Patent Publication (Kokai) No. 2005-177697).

On the other hand, the window glass is coupled to an opening and closing mechanism via a holder (or a channel). Known methods for fixing the window glass to the holder include a method of forming holes in the window glass and fixing the window glass to the holder using rivets or bolts (see, for example, Japanese Utility Model Publication (Kokoku) No. S54-038648 and Japanese Patent Publication (Kokoku) No. H06-027449) and a method of bonding the window glass and holder together using an adhesive such as a urethane adhesive without forming any hole in the window glass (see, for example, Japanese Laid-Open Utility Model Publication (Kokai) No. H06-074417). As a recent trend, the window glass and the holder are often bonded together using an adhesive without forming any hole in the window glass.

If the holder is bonded to the window glass on which a water-repellent coating is formed, using an adhesive, the water-repellent coating is desirably not formed in the part of the window glass which is bonded to the holder because the adhesive does not adhere very well to the water-repellent coating. Thus, to avoid forming the water-repellent coating in a part of the window glass, the following are performed: a method of using masking to avoid forming the water-repellent coating in a bonded portion (see, for example, Patent Japanese Laid-Open Patent Publication (Kokai) No. 2001-010337) and a method of removing the water-repellent coating from the bonded portion and its periphery (see., for example, Published Japanese Translation of PCT International Patent Publication (Tokuhyo) No. 2003-509321).

On the other hand, the method of fixing the holder to the window glass using the rivets or bolts requires a dedicated tool. Thus, the present applicants have proposed a holder (hereinafter referred to as “the lock type holder”) that can be manually fixed without the need for any tool to improve the workability (see, for example, Japanese Laid-Open Patent Publication (Kokai) No. 2004-255966).

To reduce the weight of the vehicle to save required energy, the shape of the vehicle window glass has been improved so as to minimize the area of a portion of the vehicle window glass which is accommodated inside the window of the vehicle. Specifically, as shown in FIG. 5A, to minimize a portion 503 accommodated in a door portion (window portion) 509, a window glass 500 is cut and shaped so that while the window is closed, a bottom side 500a is positioned marginally close to the boundary (glass hatch 510) between a window glass opening 508 and a door portion 509, with only holder-bonded portions 504 projecting.

On the other hand, avoiding the formation of a water-repellent coating 502 in the bonded portions 504 by means of the above method may also avoid the formation of the water-repellent coating 502 in a contact portion in which the principal surface of the window glass 500 contacts a weather strip 501 (FIG. 5B) installed in the glass hatch 510.

However, water or snow is likely to adhere to the contact portion at which the principal surface of the window glass 500 and the weather strip 501 contact each other. The adhering water or snow may be frozen to impose a heavier load on an opening and closing mechanism used to change the window glass 500 from a closed state to an open state, which may make it difficult to open the window glass 500. Here, as previously described, the formation of the water-repellent coating 502 on the glass surface is known to facilitate the release of an ice layer. However, the water-repellent coating 502 is generally considered to ensure the visibility of a driver of the vehicle. Thus, the water-repellent coating is not used to reduce the load on the opening and closing mechanism when the window glass 500 to which the frozen water or snow is adhering is changed from a closed state to an open state. Further, not all vehicle users desire the visibility improved by the water-repellent coating 502, so that the water-repellent coating 502 is not formed on all the window glasses.

### SUMMARY OF THE INVENTION

The present invention provides a vehicle window glass that can reduce the load on the opening and closing mechanism when the window glass to which frozen water or snow is adhering is changed from a closed state to an open state.

In an aspect of the present invention, there is provided a vehicle window glass according to claim 1 provides a vehicle window glass openably and closably sandwiched between weather strips comprising lip portions installed in a window portion of the vehicle and having a water-repellent coating formed on at least on one principal surface of the window glass, characterized in that the water-repellent coating is formed at least in a first contact portion at which an outer principal surface of the window glass and the lip portion placed outside the vehicle contact each other while the window glass is closed.

With this arrangement, it is possible to remove ice adhering to the first contact portion and its periphery by a relatively weak force. This enables a reduction in the load on the opening and closing mechanism when the window glass to which frozen water or snow is adhering is changed from a closed state to an open state.

The water-repellent coating can be formed at least in a second contact portion at which an inner principal surface of the window glass and the lip portion placed inside the vehicle contact each other while the window glass is closed.

With this arrangement, it is possible to remove ice adhering to the second contact portion and its periphery by a relatively weak force. This enables a reduction in the load on the opening and closing mechanism when the window glass to which frozen water or snow is adhering is changed from closed state to open state.

The water-repellent coating can be formed all over the outer principal surface of the window glass.

With this arrangement, it is possible to ensure the passenger's visibility.

The vehicle window glass can further comprise a hole portion so as to be accommodated inside the window portion of the vehicle.

With this arrangement, it is possible to eliminate the need for forming, on the window glass, a portion in which no water-repellent coating is formed. This prevents damage to the water-repellent coating formed in the contact portion and its periphery.

The vehicle window glass can further comprise a holder that couples the vehicle window glass, via the hole portion, to an opening and closing mechanism that opens and closes the window glass.

With this arrangement, it is possible to reliably couple the vehicle window glass and the opening and closing mechanism together.

The holder can be a lock type holder.

With this arrangement, it is possible to facilitate the assembly operations.

The above and other objects, features, and advantages of the invention will become more apparent from the following detailed description taken in conjunction with the accompanying drawings.

### BRIEF DESCRIPTION OF THE DRAWINGS

FIGS. 1A and 1B are views schematically showing the arrangement of a vehicle window glass according to a first embodiment of the present invention, FIG. 1A being a front view of the vehicle window glass as viewed from outside the vehicle and FIG. 1B being a vertical sectional view;

FIGS. 2A and 2B are views schematically showing the arrangement of a vehicle window glass according to a second embodiment of the present invention, FIG. 2A being a front view of the vehicle window glass as viewed from the exterior of the vehicle and FIG. 2B being a vertical sectional view;

FIGS. 3A and 3B are views schematically showing the arrangement of a vehicle window glass according to a third embodiment of the present invention, FIG. 3A being a front view of the vehicle window glass as viewed from the exterior of the vehicle and FIG. 3B being a vertical sectional view;

FIGS. 4A and 4B are views schematically showing the arrangement of a vehicle window glass according to a fourth embodiment of the present invention, FIG. 4A being a front view of the vehicle window glass as viewed from outside vehicle and FIG. 4B being a vertical sectional view; and

FIGS. 5A and 5B are views schematically showing the arrangement of a conventional vehicle window glass, FIG. 5A being a front view and FIG. 5B being a vertical sectional view.

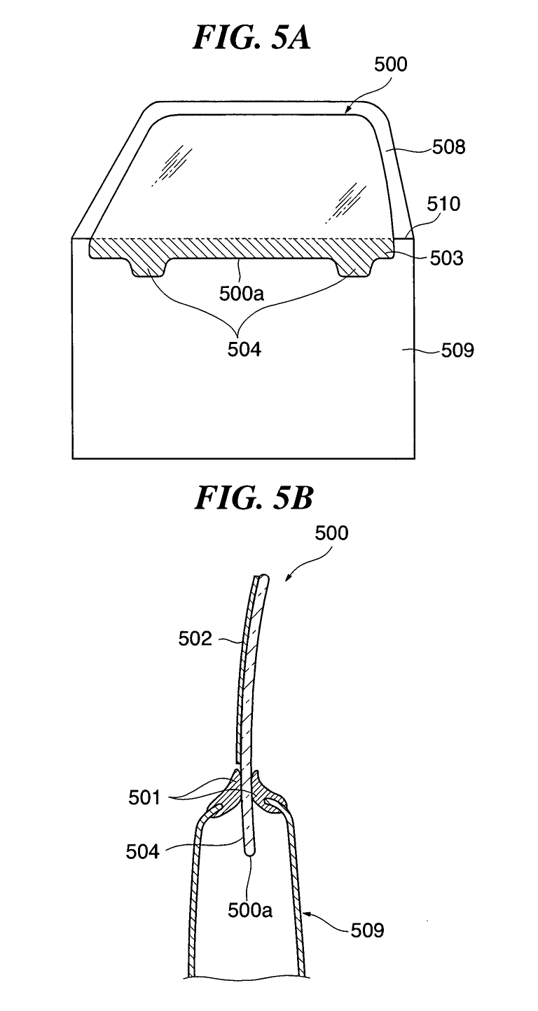

### DETAILED DESCRIPTION OF THE PREFERRED EMBODIMENTS

The present invention will now be described in detail with reference to the drawings showing preferred embodiments thereof.

### First Embodiment

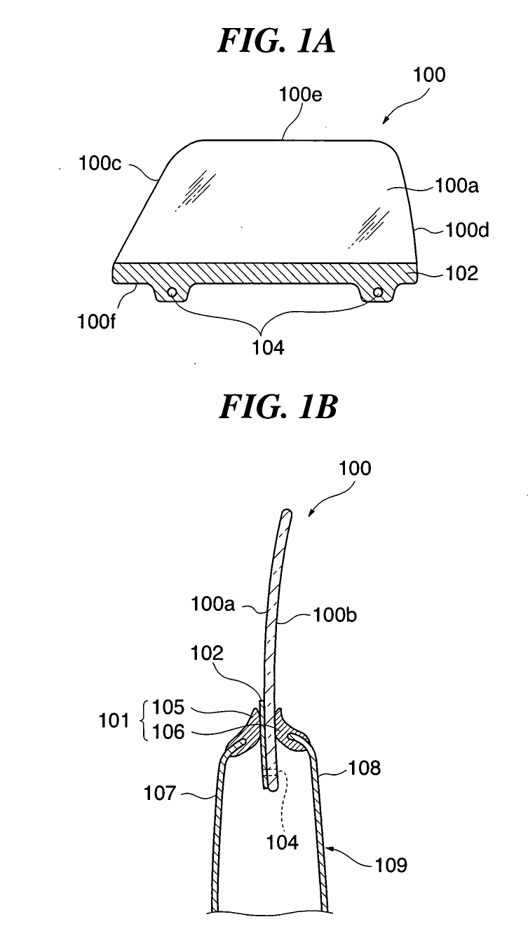

FIGS. 1A and 1B are views schematically showing the arrangement of a vehicle window glass according to a first embodiment of the present invention, FIG. 1A being a front view of the vehicle window glass as viewed from outside the vehicle and FIG. 1B being a vertical sectional view.

As the first embodiment of the present invention, an example is shown in which a vehicle window glass having a water-repellent coating formed only on the exterior surface (the water-repellent coating is not formed on an inner principal surface of the glass window (hereinafter referred to as “the interior surface”) is used in a vehicle door portion in which lateral sides and a top side have no window frame.

In FIGS. 1A and 1B, a window glass 100 is openably and closably installed on a vehicle door portion (window portion) 109 in which lateral sides 100c and 100d and a top side 100e have no window frame. Hole portions 104 are formed in a bottom side 100f of the window glass 100 to allow the window glass 100 to be coupled to an opening and closing mechanism (not shown). A water-repellent coating 102 made up of florosilicon is formed on the bottom side 100f of an exterior surface 100a of the window glass 100. The water-repellent coating 102 is not formed on an interior surface 100b of the window glass 100.

The door portion 109 comprises door structures 107 and 108 made of metal and a weather strip 101 made of resin to prevent water, dust, or the like from entering inside the door portion 109. The weather strip 101 comprises an exterior lip portion 105 provided on a top surface of the door structure 107 and an interior lip portion 106 provided on a top surface of the door structure 108. The window glass 100 is sandwiched between the exterior lip portion 105 and the interior lip portion 106. The bottom side 100f of the window glass 100 including the hole portions 104 is accommodated in the door portion 109.

A film of the water is likely to be formed in the contact portion in which the exterior surface 100a and the exterior lip portion 105 contact each other. Further, snow is likely to adhere to the periphery of the contact portion. At low temperatures, water or snow adhering to the contact portion and its periphery is frozen. When the water or snow adhering to the contact portion and its periphery is thus frozen, a load imposed on the opening and closing mechanism increases when the window glass 100 is changed from a closed state to an open state, which makes it difficult to open the window glass 100. The vehicle user can wipe off the water or snow adhering to the exterior surface 100a of the window glass 100. However, it is difficult to completely remove ice adhering to the contact portion and its periphery. Accordingly, such a situation frequently occurs.

For this situation, the water-repellent coating 102 is formed in a contact portion in which the exterior surface 100a and the exterior lip portion 105 contact each other while the window glass 100 is closed and in the periphery of the contact portion. In order for the water-repellent coating 102 to be surely formed in the contact portion, it is desirable to coat the water-repellent coating 102 on a portion about 1 to 10 mm above the contact portion.

According to this embodiment, the water-repellent coating 102 is formed in the contact portion in which the exterior surface 100a and the exterior lip portion 105 contact each other while the window glass 100 is closed and in the periphery of the contact portion. Consequently, ice adhering to the contact portion and its periphery can be removed by a relatively weak force. This enables a reduction in the load on the opening and closing mechanism when the window glass 100 to which frozen water or snow is adhering is changed from a closed state to an open state.

### Second Embodiment

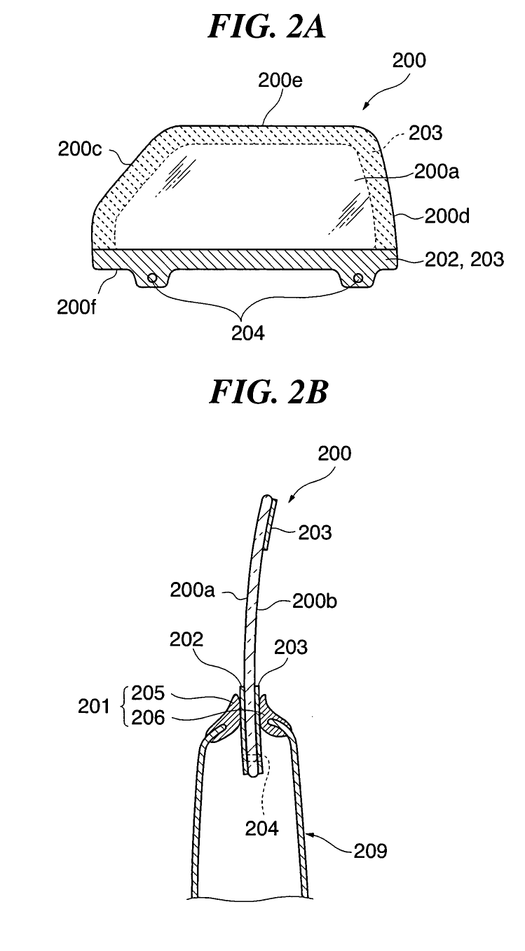

FIGS. 2A and 2B are views schematically showing the arrangement of a vehicle window glass according to a second embodiment of the present invention, FIG. 2A being a front view of the vehicle window glass as viewed from the outside of the vehicle and FIG. 2B being a vertical sectional view.

As the second embodiment of the present invention, an example is shown in which a vehicle window glass having a water-repellent coating formed both on the exterior surface and on the interior surface is used in a vehicle door portion in which lateral sides and a top side have no window frame.

Here, in the second embodiment, the same components as those in the first embodiment will not be described.

In FIGS. 2A and 2B, a window glass 200 is openably and closably installed in a vehicle door portion 209 in which lateral sides 200c and 200d and a top side 200e have no window frame. Hole portions 204 are formed in a bottom side 200f of the window glass 200 to allow the window glass 200 to be coupled to an opening and closing mechanism (not shown). A water-repellent coating 202 made up of florosilicon is formed on the bottom side 200f of exterior surface 200a of the window glass 200. A water-repellent coating 203 made up of florosilicon is formed all along the periphery (lateral sides 200c and 200d, a top side 200e, and a bottom side 200f) of an interior surface 200b of the window glass 200.

While the window glass 200 is closed, the lateral sides 200c and 200d and the top side 200e are abutted against a weather strip (not shown) provided in a body (a roof, and pillars supporting the roof) instead of a window frame for a door portion 209 of the vehicle.

In some car types in which the window glass 200 is entirely accommodated in the door portion 209, when the window glass 200 lowers and is entirely accommodated in the door portion 209, the exterior lip portion 205 and the interior lip portion 206 come into contact with each other. This prevents water, dust, or the like from entering inside the door portion 209. The contact between the exterior lip portion 205 and the interior lip portion 206 transfers water or snow adhering to the exterior lip portion 205 to the interior lip portion 206. In this state, raising the window glass 200 partly enables a part of the water or snow adhering to the interior lip portion 206 to be transferred to the interior surface 200b of the window glass 200. When the door portion 209 or the window glass 200 is opened or closed, water or snow may also adhere to the lip portion of the weather strip (not shown), against which the lateral sides 200c and 200d and the top side 200e of the window glass 200 are abutted.

For this situation, the water-repellent coating 203 is formed in a contact portion in which the interior surface 200b and the interior lip portion 206 contact each other while the window glass 200 is closed and in the periphery of the contact portion as well as in a contact portion in which while the window glass 200 is closed, the interior surface 200b contacts the lip portion of the weather strip (not shown), against which the lateral sides 200c and 200d and the top side 200e of the window glass 200 are abutted, and in the periphery of the contact portion. In order for the water-repellent coating 203 to be formed in the contact portions, it is desirable to coat the water-repellent coating 203 on a peripheral portion extending about 1 to 10 mm from the contact portion.

According to this embodiment, in addition to the water-repellent coating 202, the water-repellent coating 203 is formed in the contact portion in which the interior surface 200b and the interior lip portion 206 contact each other while the window glass 200 is closed and in the periphery of the contact portion as well as in the contact portion in which while the window glass 200 is closed, the interior surface 200b contacts the lip portion of the weather strip (not shown), against which the lateral sides 200c and 200d and top side 200e of the window glass 200 are abutted, and in the periphery of the contact portion. Consequently, ice adhering to the contact portion and its periphery can be removed by a relatively weak force. This enables a reduction in the load on the opening and closing mechanism when the window glass 200 to which frozen water or snow are adhering is changed from a closed state to an open state.

### Third Embodiment

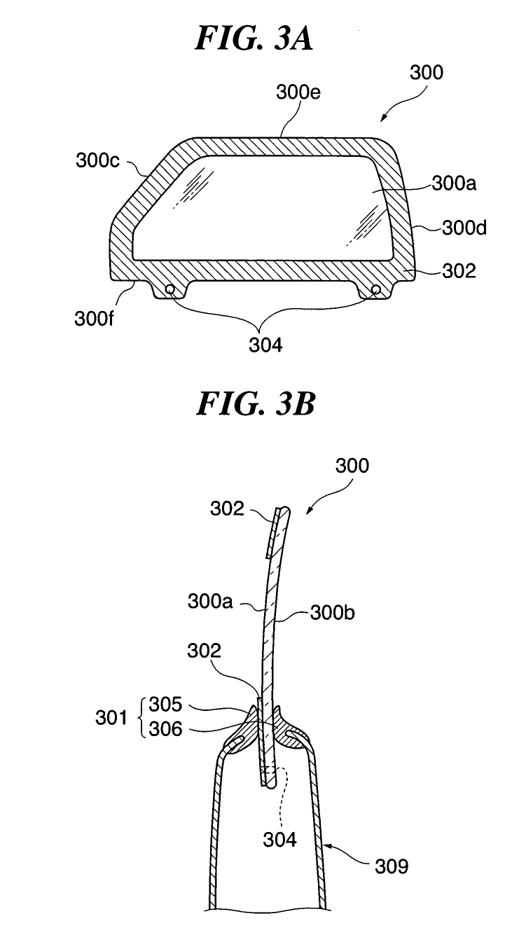

FIGS. 3A and 3B are views schematically showing the arrangement of a vehicle window glass according to a third embodiment of the present invention, FIG. 3A being a front view of the vehicle window glass as viewed from the outside of the vehicle and FIG. 3B being a vertical sectional view.

As the third embodiment of the present invention, an example is shown in which a vehicle window glass having a water-repellent coating formed only on the exterior surface (the water-repellent coating is not formed on the interior surface) is used in a vehicle door portion having window frames.

Here, in the third embodiment, the same components as those in the first and second embodiments will not be described.

In FIGS. 3A and 3B, a window glass 300 is openably and closably installed in a vehicle door portion 309 having window frames on a bottom side 300f, lateral sides 300c and 300d and top side 300e. Hole portions 304 are formed in the bottom side 300f of the window glass 300 to allow the window glass 300 to be coupled to an opening and closing mechanism (not shown) . A water-repellent coating 302 made up of florosilicon is formed all along the periphery (lateral sides 300c and 300d, a top side 300e, and a bottom side 300f) of an exterior surface 300a of the window glass 300. The water-repellent coating 302 is not formed on the interior surface 300b.

A weather strip 301 (an exterior lip portion 305 and an interior lip portion 306) is formed all along the inner periphery of window frame of the door portion 309, that is, for not only the bottom side 300f but also the lateral sides 300c and 300d and the top side 300e of the window glass 300.

Thus, the water-repellent coating 302 is formed in a contact portion in which the exterior surface 300a and the exterior lip portion 305 contact each other while the window glass 300 is closed and in the periphery of the contact portion.

According to this embodiment, the water-repellent coating 302 is formed in the contact portion in which the exterior surface 300a and the exterior lip portion 305 contact each other while the window glass 300 is closed and in the periphery of the contact portion. Consequently, ice adhering to the contact portion and its periphery can be removed by a relatively weak force. This enables a reduction in the load on the opening and closing mechanism when the window glass 300 to which frozen water or snow is adhering is changed from a closed state to an open state.

### Fourth Embodiment

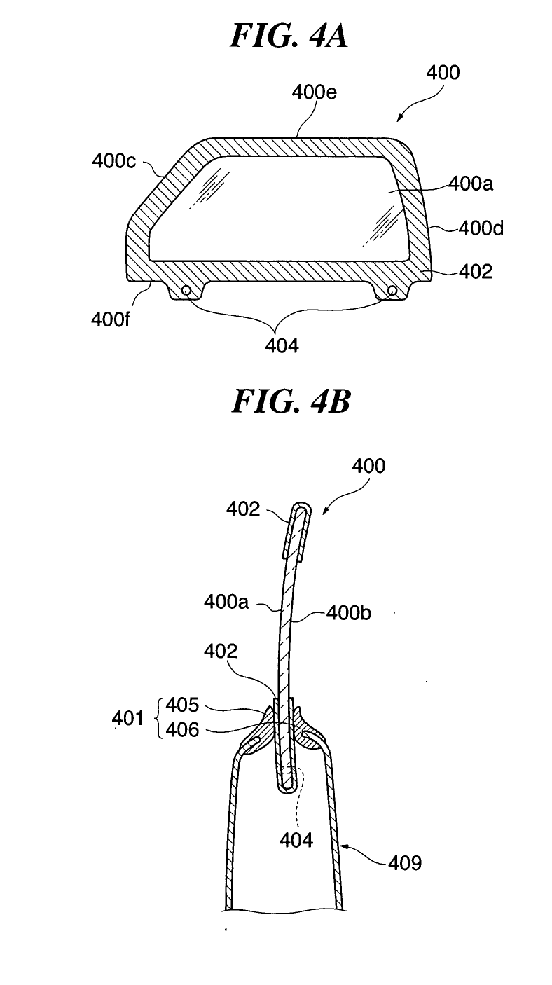

FIGS. 4A and 4B are views schematically showing the arrangement of a vehicle window glass according to a fourth embodiment of the present invention, FIG. 4A being a front view of the vehicle window glass as viewed from the outside of the vehicle and FIG. 4B being a vertical sectional view.

As the fourth embodiment of the present invention, an example is shown in which a vehicle window glass having a water-repellent coating formed both on the exterior surface and on the interior surface is used in a vehicle door portion having window frames.

Here, in the fourth embodiment, the same components as those in the first to third embodiments will not be described.

In FIGS. 4A and 4B, a window glass 400 is openably and closably installed in a vehicle door portion 409 having window frames (not shown) on a bottom side 400f, lateral sides 400c and 400d, and a top side 400e. Hole portions 404 are formed in the bottom side 400f of the window glass 400 to allow the window glass 400 to be coupled to an opening and closing mechanism (not shown). A water-repellent coating 402 made up of florosilicon is formed all along the periphery (lateral sides 400c and 400d, top side 400e, and a bottom side 400f) of an exterior surface 400a and an interior surface 400b of the window glass 400.

A weather strip 401 (an exterior lip portion 405 and an interior lip portion 406) is formed all along the inner periphery of window frame of the door portion 409, that is, for not only the bottom side 400f but also the lateral sides 400c and 400d and the top side 400e of the window glass 400.

Thus, the water-repellent coating 402 is formed in the contact portion in which the exterior surface 400a (the interior surface 400b) and the exterior lip portion 405 (the interior lip portion 406) contact each other while the window glass 400 is closed and in the periphery of the contact portion.

According to this embodiment, the water-repellent coating 402 is formed in the contact portion in which the exterior surface 400a (the interior surface 400b) and the exterior lip portion 405 (the interior lip portion 406) contact each other while the window glass 400 is closed and in the periphery of the contact portion. Consequently, ice adhering to the contact portion and its periphery can be removed by a relatively weak force. This enables a reduction in the load on the opening and closing mechanism when the window glass 400 to which frozen water or snow is adhering is changed from a closed state to an open state.

In the first to fourth embodiments, the weather strip 101, 201, 301, or 401 has one exterior lip portion and one interior lip portion 105 and 106, 205 and 206, 305 and 306, 405 and 406, respectively. However, the present invention is not limited to this. The weather strip may have two or more exterior lip portions and two or more interior lip portions. In this case, the water-repellent coating 102, 202, 203, 302, or 402 is formed within the range in which it contacts the two or more lip portions.

In the first to fourth embodiments, the water-repellent coatings 102, 202, 203, 302, and 402 are formed in the contact portions in which the exterior surface 100a, 200a, 300a, or 400a of the window glass 100, 200, 300, or 400 contact the exterior lip portions 105, 205, 305, or 405, and in the peripheries of the contact portions. However, the water-repellent coating 102, 202, 203, 302, or 402 may be formed, as required, all over the exterior surface 100a, 200a, 300a, or 400a and/or the interior surface 100b, 200b, 300b, or 400b of the window glass 100, 200, 300, or 400. This ensures the passenger's visibility. Alternatively, the water-repellent coating 102 may be formed so as not to be accommodated in the door portion 109 when the window glass 100, 200, 300, or 400 is fully open, that is, may be formed at the edges and on the end surfaces of the window glass 100, 200, 300, or 400 (FIG. 4).

Each of the first to fourth embodiments involve two hole portions 104, 204, 304, or 404. However, the present invention is not limited thereto. One or more hole portions 104, 204, 304, or 404 may be formed depending on the type of the opening and closing mechanism. Since the window glass 100, 200, 300, or 400 is coupled to the opening and closing mechanism via the hole portions 104, 204, 304, or 404, it is possible to eliminate the need for forming, on the window glass 100, 200, 300, 400, a portion at which the water-repellent coating 102, 202, 203, 302, or 402 is not formed. This prevents damage to the water-repellent coatings 102, 202, 302, and 402 each formed in the contact portion and its periphery.

The window glass 100, 200, 300, or 400 may be coupled directly to the opening and closing mechanism via the hole portions 104, 204, 304, or 404 or may be coupled indirectly to the opening and closing mechanism via a holder attached to the hole portions 104, 204, 304, or 404 in order to facilitate the assembly operations. The holder may be a common one that uses existing rivets or bolts or the lock type described in Japanese Laid-Open Patent Publication (Kokai) No. 2004-255966. As compared with a typical holder, the lock type holder does not require any tool and can be manually fixed to the window glass 100, 200, 300, or 400. Accordingly, the lock type holder is desirably used in terms of the assembly operability.

In the first to forth embodiments, florosilicon is used as the water-repellent coatings 102, 202, 203, 302, or 402. However, the present invention is not limited thereto. Any material may be used as long as it provides the window glass 100, 200, 300, or 400 with a water-repellent function.

The first to fourth embodiments have been described in conjunction with the case where the present invention is applied to the vehicle window glass 100, 200, 300, or 400. However, the present invention is not limited thereto. The present invention may be applied to, for example, a roof glass of a vehicle or slide glasses on sides of a vehicle.

The above-described embodiments are merely exemplary of the present invention, and are not to be construed to limit the scope of the present invention.

The scope of the present invention is defined by the scope of the appended claims, and is not limited to only the specific description in this specification. Furthermore, all modifications and changes belonging to equivalents of the claims are considered to fall within the scope of the present invention.

This application claims the benefit of Japanese Patent Application No. 2006-106217 filed Apr. 7, 2006, which is hereby incorporated by reference herein in its entirety.

What is claimed is:

1. A vehicle window glass openably and closably sandwiched between weather strips comprising lip portions installed in a window portion of the vehicle and having a water-repellent coating formed on at least on one principal surface of the window glass, characterized in that
the water-repellent coating is formed at least in a first contact portion at which an outer principal surface of the window glass and the lip portion placed outside the vehicle contact each other while the window glass is closed.

2. A vehicle window glass according to claim 1, characterized in that the water-repellent coating is formed at least in a second contact portion at which an inner principal surface of the window glass and the lip portion placed inside the vehicle contact each other while the window glass is closed.

3. A vehicle window glass according to claim 1, characterized in that the water-repellent coating is formed all over the outer principal surface of the window glass.

4. A vehicle window glass according to claim 1, characterized by comprising a hole portion formed so as to be accommodated inside the window portion of the vehicle.

5. A vehicle window glass according to claim 4, characterized by comprising a holder that couples the vehicle window glass, via the hole portion, to an opening and closing mechanism that opens and closes the window glass.

6. A vehicle window glass according to claim 5, characterized in that the holder is a lock type holder.
